(19) United States
(12) Patent Application Publication
(10) Pub. No.: US 2008/0313656 A1
(43) Pub. Date: Dec. 18, 2008

(54) User mode stack disassociation

(75) Inventors: Matthew D. Klein, Seattle, WA (US); Paul England, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/820,164

(22) Filed: Jun. 18, 2007

(51) Int. Cl. G06F 9/44

(52) U.S. Cl. 719/320

(57) ABSTRACT

Various technologies and techniques are disclosed for allowing a user mode stack to be shared by multiple contexts. A user mode stack can be shared between execution contexts that are guaranteed to not need the user mode stack at the same time. For example, each user mode portion of a kernel thread is provided with a dedicated backing thread. When a respective dedicated backing thread is sleeping and not using a respective user mode stack, the user mode stack is allowed to float with a respective user mode portion to other kernel threads. The user mode stack is disassociated from the kernel portion of the thread. The kernel is notified of an address of a user mode thread context. The kernel mode portion of the converted thread becomes a backing thread that waits. The user mode portion of the converted thread can be switched without entering the kernel.

### BACKGROUND

Software developers develop software by writing source code in one or more programming languages. These programming languages and the operating systems that support them utilize a common standard for stack manipulation. Under this standard, function calls take place on a stack by pushing and popping values, and the stack can be traversed during debugging and exception handling to produce a call graph. The operating systems typically utilize separate stacks for execution that takes place in user-mode versus execution that takes place in kernel-mode. Special operating system code transfers state between the two stacks at security boundaries. When inside of the kernel, by the trap frame, the call stack can be unwound out of the kernel and into user-mode.

Different execution contexts have stack layouts based on their respective uses. In MICROSOFT® WINDOWS®, for example, a thread has a user-mode stack and a kernel-mode stack so it can move back and forth between the two protection areas. A fiber only has a user-mode stack and contains no associated kernel mode data structures (stack, etc.). A fiber uses the kernel-mode stack and control structures of the underlying thread whenever it enters the kernel. This means that it is possible to multiplex many fibers on top of a single thread.

The problem, however, is that many system services associate state with both the kernel and user portions of a thread. This is a problem because a user mode thread that makes a system call may set state in the kernel portion of the underlying thread that a subsequent user mode thread may read leading to inconsistent state.

### SUMMARY

Various technologies and techniques are disclosed for allowing a user mode stack to be shared by multiple contexts. A user mode stack can be shared between at least two execution contexts that are guaranteed to not need the user mode stack at a same time. For example, each user mode portion of a kernel thread is provided with a dedicated backing thread. When a respective dedicated backing thread is sleeping and not using a respective user mode stack, the user mode stack is allowed to float with a respective user mode portion to other kernel threads.

In one implementation, the user mode stack is disassociated from the kernel portion of the thread. The kernel is notified of an address, of a user mode thread context. The kernel mode portion of the converted thread becomes a backing thread that waits using a kernel mode wait primitive. A user mode runtime is then allowed to switch the user mode portion of the converted thread without entering the kernel.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a user mode stack disassociation application of one implementation operating on the computer system of FIG. 1.

FIG. 3 is a process flow diagram for one implementation of the system of FIG. 1 illustrating the stages involved in sharing user mode stack between two contexts.

FIG. 4 is a process flow diagram for one implementation of the system of FIG. 1 illustrating the high level stages involved in disassociating the user mode stack from the kernel portion of the thread.

FIG. 5 is a process flow diagram for one implementation of the system of FIG. 1 illustrating the stages involved in creating/converting a user mode portion of a thread.

FIG. 6 is a process flow diagram for one implementation of the system of FIG. 1 illustrating the stages involved in notifying the kernel of the address of the user mode thread context.

FIG. 7 is a process flow diagram for one implementation of the system of FIG. 1 that illustrates the stages involved in switching a user mode portion of a thread to a backing thread.

FIG. 8 is a process flow diagram for one implementation of the system of FIG. 1 that illustrates the stages involved in performing a context restoration procedure.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that allows a user mode stack to be shared in multiple contexts, but the system also serves other purposes in addition to these. In one implementation, one or more of the techniques described herein can be implemented as features within an operating system program such as MICROSOFT® WINDOWS®, or from any other type of program or service that manages and/or executes threads.

In one implementation, each user mode portion of a kernel thread is provided with a dedicated backing thread. Then, when a respective dedicated backing thread is sleeping and not using a respective user mode stack, the user mode stack is allowed to float with a respective user mode portion to other kernel threads. A stack disassociation process is performed in order to allow the user mode stack to float to other kernel threads. In one implementation, by allowing the user mode stack to be shared in multiple contexts, a space savings is realized because fewer stacks are needed.

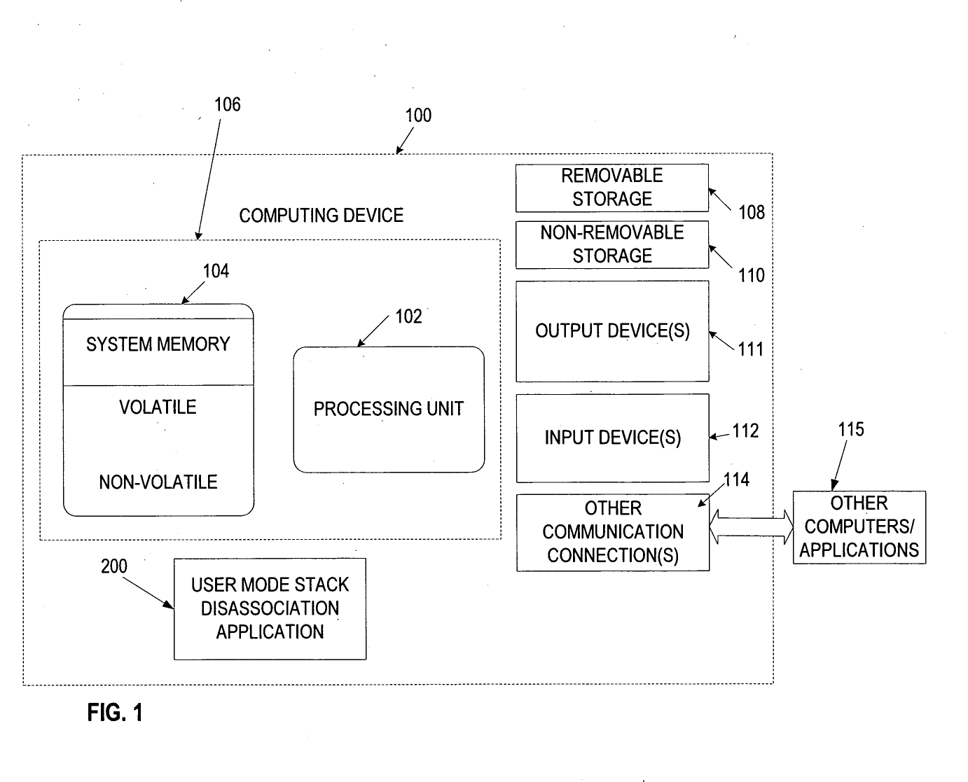

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

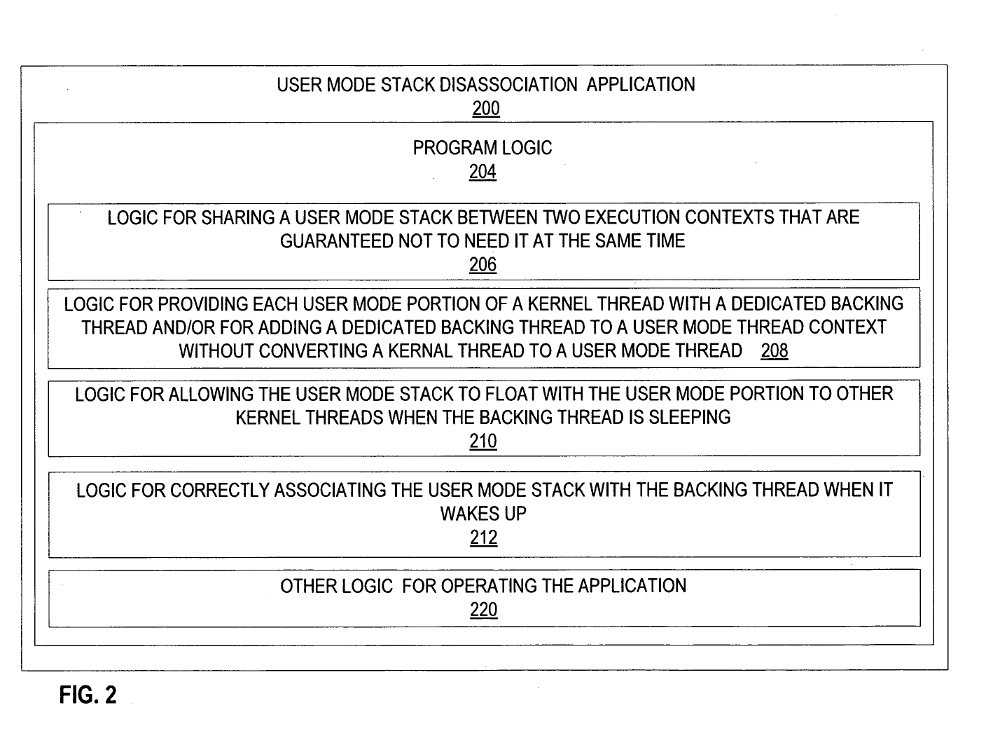

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes user mode stack disassociation application 200. User mode stack disassociation application 200 will be described in further detail in FIG. 2.

Turning now to FIG. 2 with continued reference to FIG. 1, a user mode stack disassociation application 200 operating on computing device 100 is illustrated. User mode stack disassociation application 200 is one of the application programs that reside on computing device 100. However, it will be understood that user mode stack disassociation application 200 can alternatively or additionally be embodied as computer-executable instructions on one or more computers and/or in different variations than shown on FIG. 1. Alternatively or additionally, one or more parts of user mode stack disassociation application 200 can be part of system memory 104, on other computers and/or applications 115, or other such variations as would occur to one in the computer software art.

User mode stack disassociation application 200 includes program logic 204, which is responsible for carrying out some or all of the techniques described herein. Program logic 204 includes logic for sharing a user mode stack between two execution contexts that are guaranteed not to need it at the same time 206; logic for providing each user mode portion of a kernel thread with a dedicated backing thread and/or for adding a dedicated backing thread to a user mode thread context without converting a kernel thread to a user thread 208; logic for allowing the user mode stack to float with the user mode portion to other kernel threads when the backing thread is sleeping 210; logic for correctly associating the user mode stack with the backing thread when it wakes up 212; and other logic for operating the application 220. In one implementation, program logic 204 is operable to be called programmatically from another program, such as using a single call to a procedure in program logic 204.

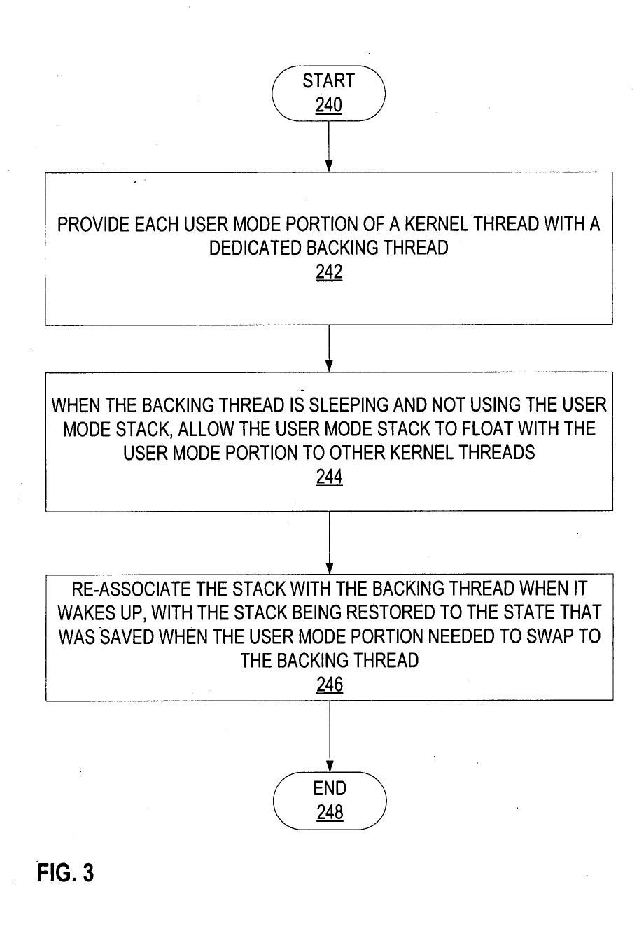

Turning now to FIGS. 3-9 with continued reference to FIGS. 1-2, the stages for implementing one or more implementations of user mode stack disassociation application 200 are described in further detail. FIG. 3 illustrates one implementation of the stages involved in sharing user mode stack between two contexts. In one form, the process of FIG. 3 is at least partially implemented in the operating logic of computing device 100. The process begins at start point 240 with the system providing each user mode portion of the kernel thread with a dedicated backing thread (stage 242). When the backing thread is sleeping and not using the user mode stack, the user mode stack is allowed to float with the user mode portion to other kernel threads (stage 244). The system re-associates the stack with the backing thread when it wakes up, with the stack being restored to the state that was saved when the user mode portion needed to swap to the backing thread (stage 246). The process ends at end point 248.

In one implementation, from the time that one execution context stops using its user mode stack, to the time that it sleeps and signals another execution context to use the stack, it must not use the stack for any procedure calls, memory operations, etc. This prevents the user mode stack from being corrupted if the other execution context begins running on another processor and starts using the stack before the first execution context stops using it.

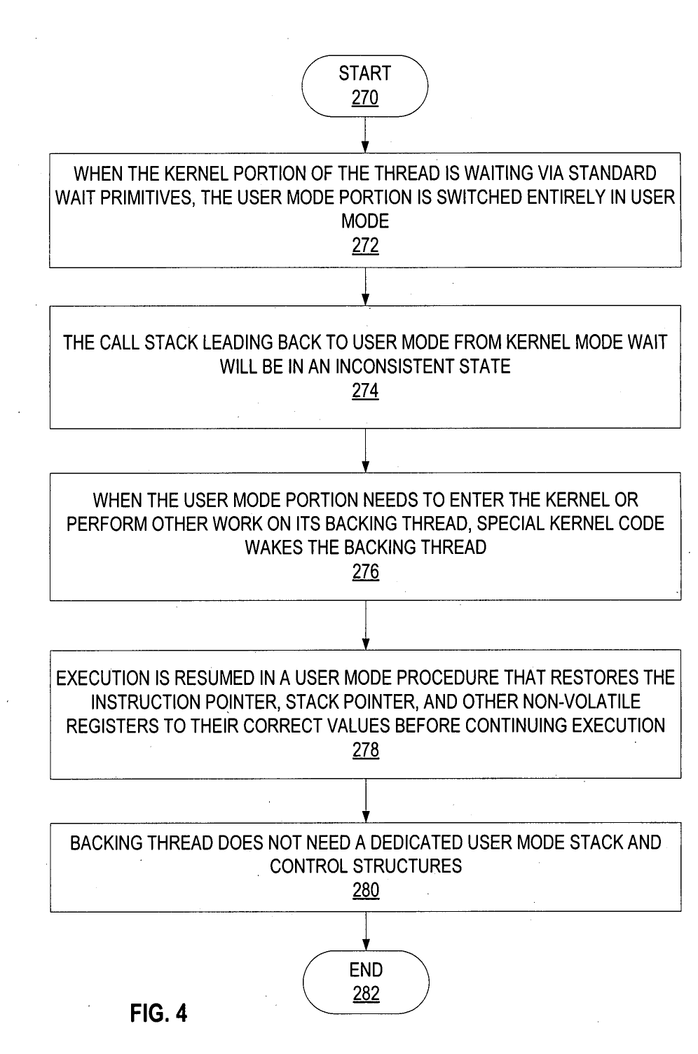

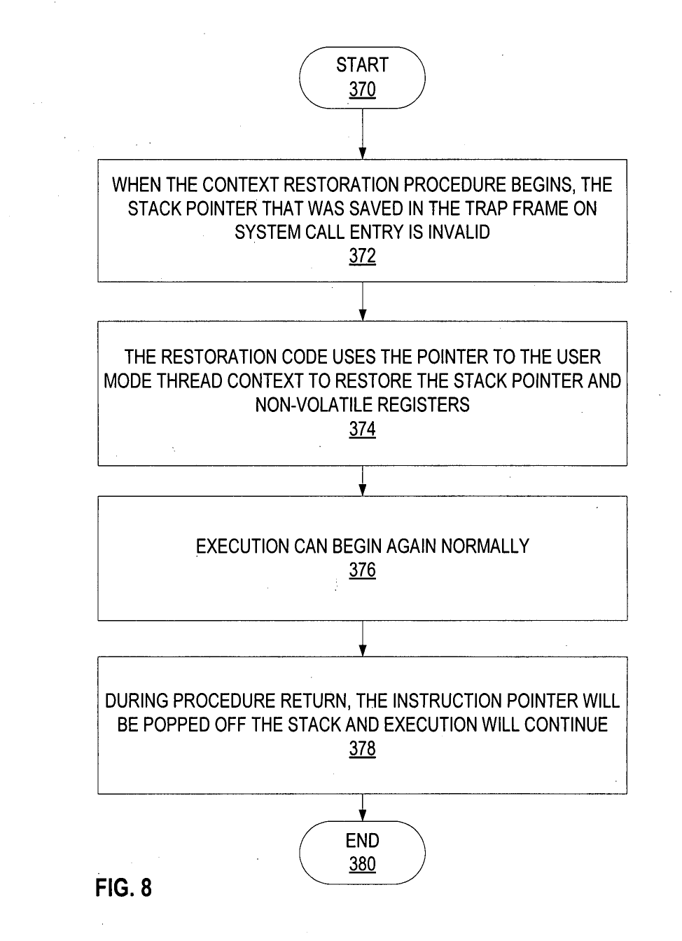

FIG. 4 illustrates one implementation of the high level stages involved in disassociating the user mode stack from the kernel portion of the thread. In one form, the process of FIG. 4 is at least partially implemented in the operating logic of computing device 100. The process begins at start point 270 with switching the user mode portion entirely in user mode when the kernel portion of the thread is waiting via standard wait primitives (stage 272). At this point in time, the call stack leading back to the user mode from the kernel mode wait will be in an inconsistent state (stage 274). When the user mode portion needs to enter the kernel or perform other work on its backing thread, special kernel code wakes the backing thread (stage 276). As described in further detail in FIG. 8, execution is resumed in a user mode procedure that restores the instruction pointer, stack pointer, and other non-volatile registers to their correct values before continuing execution (stage 278). By using some or all of these techniques, the backing thread does not need dedicated user mode stack and control structures (stage 280), thereby saving some allocation space. The process ends at end point 282.

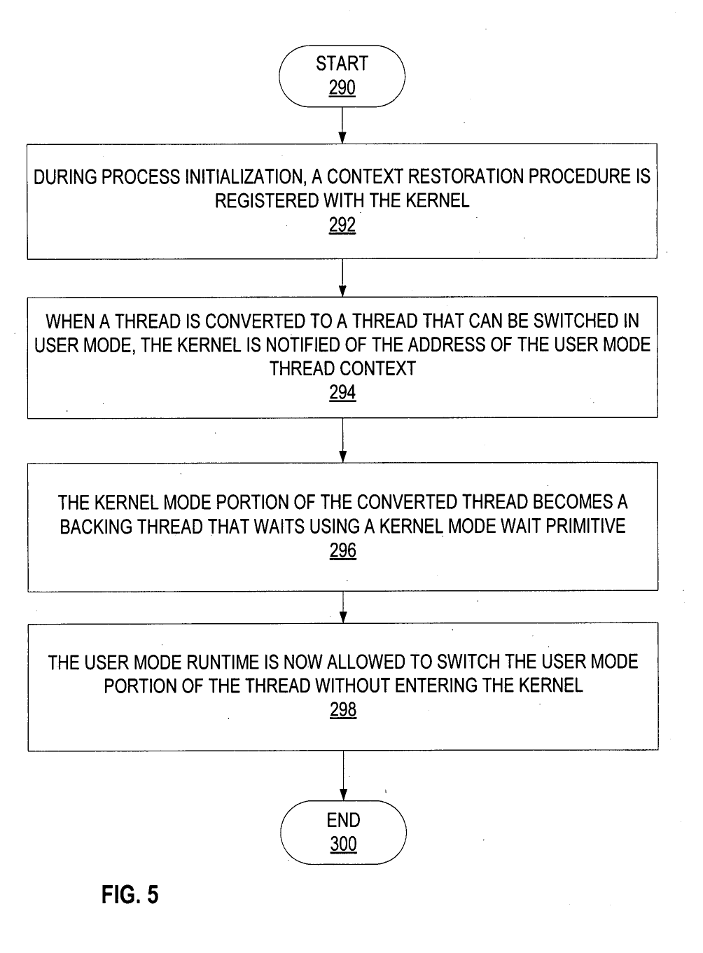

FIG. 5 illustrates one implementation of the stages involved in creating/converting a user mode portion of a thread. In one form, the process of FIG. 5 is at least partially implemented in the operating logic of computing device 100. The process begins at start point 290 registering the context restoration procedure with the kernel during the process initialization (stage 292). When a thread is converted to a thread that can be switched in user mode, the kernel is notified of the address of the user mode thread context (stage 294). The kernel mode portion of the converted thread becomes a backing thread that waits using a kernel mode wait primitive (stage 296). The user mode runtime is now allowed to switch the user mode portion of the thread without entering the kernel (stage 298). The process ends at end point 300.

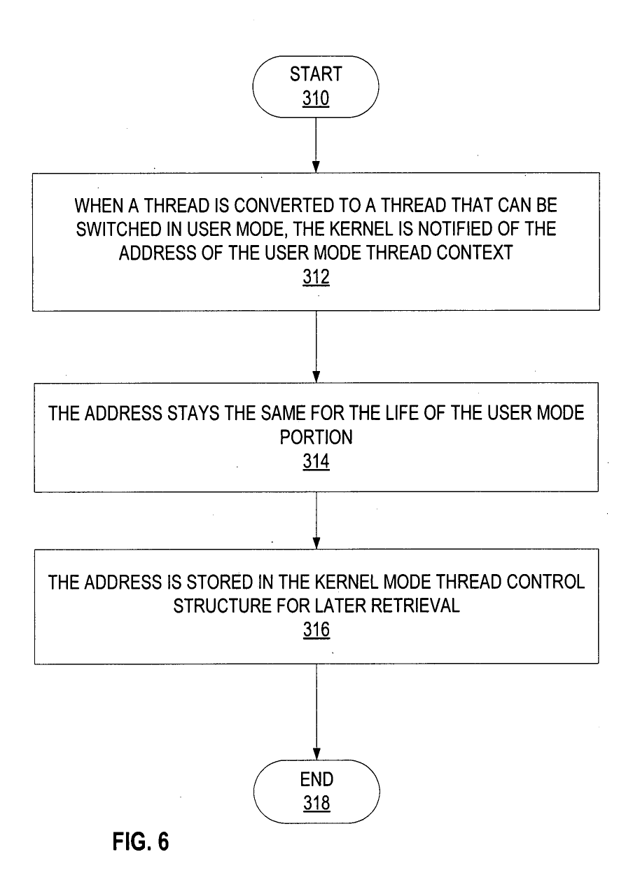

FIG. 6 illustrates one implementation of the stages involved in notifying the kernel of the address of the user mode thread context. In one form, the process of FIG. 6 is at least partially implemented in the operating logic of computing device 100. The process begins at start point 310 with notifying the kernel of the address of the user mode fast thread context when a thread is converted to a thread that can be switched to user mode (stage 312). The address stays the same for the life of the user mode portion (stage 314). The address is stored in the kernel mode thread control structure for later retrieval (stage 316). The process ends at end point 318.

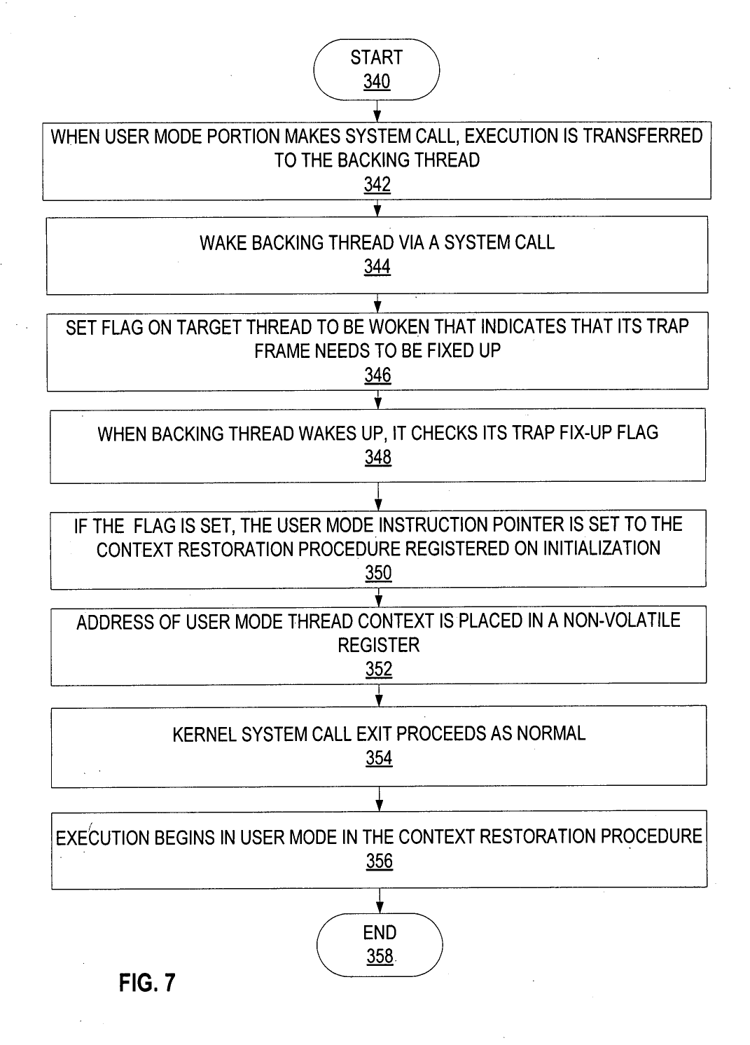

FIG. 7 illustrates one implementation of the stages involved in switching a user mode portion of a thread to a backing thread. In one form, the process of FIG. 7 is at least partially implemented in the operating logic of computing device 100. The process begins at start point 340 with transferring execution to the backing thread when the user mode portion makes a system call (stage 342). The backing thread is woken by a system call (stage 344). The system sets a flag on the target thread to be woken that indicates that its trap frame needs to be fixed up (stage 346). When the backing thread wakes up, it checks its trap fix-up flag (stage 348). If the flag is set, the user mode instruction pointer is set to the context restoration procedure registered on initialization (stage 350). The address of user mode thread context is placed in a non-volatile register (stage 352). The kernel system call exit proceeds as normal (stage 354). The execution begins in user mode in the context restoration procedure (stage 356), as described in further detail in FIG. 8. The process ends at end point 358.

FIG. 8 illustrates one implementation of the stages involved in performing a context restoration procedure. In one form, the process of FIG. 8 is at least partially implemented in the operating logic of computing device 100. The process begins at start point 370. When the context restoration procedure begins, the stack pointer that was saved in the trap frame on system call entry is invalid (stage 372). Thus, the restoration code uses the pointer to the user mode thread context to restore the stack pointer and non-volatile registers (stage 374). Execution can now begin again normally (stage 376). During procedure return, the instruction pointer will be popped off the stack and execution will continue (stage 378). The process ends at end point 380.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
share a user mode stack between at least two execution contexts that are guaranteed to not need the user mode stack at a same time.

2. The computer-readable medium of claim 1, wherein one of the at least two execution contexts is a kernel thread other than an initial kernel thread that is initially associated with the user mode stack.

3. The computer-readable medium of claim 1, wherein one of the at least two execution contexts is a dedicated backing thread.

4. The computer-readable medium of claim 1, further having computer-executable instructions for causing a computer to perform steps comprising:
provide a user mode portion of a kernel thread with a dedicated backing thread, with the user mode stack being assigned to the user mode portion.

5. The computer-readable medium of claim 4, wherein the user mode stack floats with the user mode portion to other kernel threads when the dedicated backing thread is sleeping.

6. The computer-readable medium of claim 5, wherein the user mode stack is correctly re-associated with the dedicated backing thread when the dedicated backing thread wakes up.

7. A method for sharing a user mode stack between multiple contexts comprising the steps of:
providing each user mode portion of a kernel thread with a dedicated backing thread; and
when a respective dedicated backing thread is sleeping and not using a respective user mode stack, allowing the user mode stack to float with a respective user mode portion to other kernel threads.

8. The method of claim 7, further comprising:
re-associating the respective user mode stack with the respective backing thread when the respective backing thread wakes up.

9. The method of claim 7, wherein the respective backing thread is woken up when the user mode portion needs to perform work on the respective backing thread.

10. The method of claim 9, wherein execution is resumed in a user mode procedure that restores correct values before continuing execution.

11. The method of claim 10, wherein the correct values include an instruction pointer.

12. The method of claim 10, wherein the correct values include a stack pointer.

13. The method of claim 10, wherein the correct values include non-volatile register values.

14. The method of claim 7, wherein the respective user mode stack is not dedicated to the backing thread.

15. A computer-readable medium having computer-executable instructions for causing a computer to perform the steps recited in claim 7.

16. A method for disassociating a user mode stack from a kernel portion of a thread comprising the steps of:
when a particular thread is converted to a converted thread that can be switched in user mode, notifying a kernel of an address of a user mode thread context;
a kernel mode portion of the converted thread becomes a backing thread that waits using a kernel mode wait primitive; and
allowing a user mode runtime to switch a user mode portion of the converted thread without entering the kernel.

17. The method of claim 16, wherein during process initialization, a context restoration procedure is registered with the kernel.

18. The method of claim 16, wherein the address remains constant for a life of the user mode portion.

19. The method of claim 16, wherein the address is stored in a kernel mode thread control structure for later retrieval.

20. A computer-readable medium having computer-executable instructions for causing a computer to perform the steps recited in claim 16.
